(19) United States
(12) Patent Application Publication
(10) Pub. No.: US 2012/0183448 A1
(43) Pub. Date: Jul. 19, 2012

(54) METHOD AND APPARATUS FOR TEMPERATURE INCREASE OF EXHAUST OR PROCESS GASES WITH AN OXIDIZABLE SHARE

(76) Inventor: Rainer Maierhofer, Klosterneuburg (AT)

(21) Appl. No.: 13/347,185

(22) Filed: Jan. 10, 2012

(30) Foreign Application Priority Data
Jan. 13, 2011 (AT) A 50/2011

(51) Int. Cl. B01D 53/56; B01D 53/62

(52) U.S. Cl. 422/170; 423/246

(57) ABSTRACT

A method and a device for increasing the temperature of an exhaust gas or process gas with an oxidizable share, in particular a carbon monoxide-containing nitrogen oxide flue gas, before a catalytic flue gas denitrification is performed, wherein an exhaust gas or flue gas duct is in communication with at least one hot gas duct designed as a combustion chamber which hot gas duct is assigned with a combustion device, so that the oxidizable share, in particular the carbon monoxide share, of the exhaust gas or flue gas conducted through the hot gas duct is oxidized at least partially in particular to carbon dioxide.

### BACKGROUND

The invention relates to a method for increasing the temperature of an exhaust gas or process gas with an oxidizable share, in particular a carbon monoxide-containing nitrogen oxide flue gas, before a catalytic flue gas denitrification is performed, and to a device for increasing the temperature of an exhaust gas or process gas with an oxidizable share, in particular a carbon monoxide-containing nitrogen oxide flue gas, comprising an exhaust gas or flue gas duct through which the exhaust gas or process gas, in particular the nitrogen oxide flue gas, is conducted, and a denitrification unit for denitrifying the exhaust gas or process gas.

In thermal and chemical processes, nitrous gases, also referred to as nitrogen oxides, are produced by the oxidation of nitrogen compounds. Emission guidelines rule that these nitrogen oxide compounds have to be reduced, i.e. have to be reduced to the elementary particles nitrogen and oxygen by means of denitrification. Known methods provide, on the one hand, the addition of ammonia or various catalysts, respectively, for the denitrification of flue gases. In the catalytic processes it is often necessary to increase the flue gas temperatures to the respective reaction temperature of the catalyst. This is usually performed by heating with the aid of a heat exchanger, and a further heating by means of external energy sources such as, for instance, superheated steam or fossil primary fuels. This heating of the nitrogen oxide flue gas for or prior to a catalytic denitrification has the disadvantage of being cost-intensive due to the high consumption of fossil fuels.

JP 2002-047986 A deals with the exhaust gas purification of combustion engines. To this end, an oxidation catalyst and a collecting filter for particles contained in the exhaust gas flow are arranged consecutively in the exhaust gas duct of a diesel engine. The oxidation catalyst effects a conversion of nitrogen monoxide (NO) to nitrogen dioxide (NO₂), whereby the precipitation of particles is to be promoted. The conversion rate of NO to NO₂ depends on the exhaust gas temperature. If the exhaust gas temperature undercuts a value Tₒₓᵢ at which a predetermined conversion rate NO/NO₂ is achieved, the emission of carbon monoxide (CO) is i.a. increased; CO is converted to carbon dioxide (CO₂) in the oxidation catalyst, wherein the exhaust gas temperature is increased due to the released reaction heat and hence the NO₂ conversion rate is increased.

DE 196 53 958 A1 furthermore discloses a method for reducing the nitrogen oxides in the exhaust gas of combustion engines, wherein an exhaust gas emanating from an engine is discharged to the ambient air through a reduction catalyst. In the reduction catalyst, the nitrogen oxides contained in the exhaust gas are reduced with simultaneous oxidation of hydrocarbons and carbon monoxide. The conversion rates for the pollutant components are strongly dependent on the exhaust gas temperature. In order to keep the exhaust gas temperature in front of the reduction catalyst always in the optimum operating range, even if the engine exit temperature of the exhaust gas is substantially higher, the exhaust gas duct is connected with a supply pipe for fresh air. The fresh air is blown into the exhaust gas by means of an air pump. The air pump is controlled by a controller such that the exhaust gas temperature that is measured just before the catalyst by means of a thermal element has a predefined constant value.

JP 2005-193175 furthermore describes a technology for treating the exhaust gases of combustion engines, wherein the exhaust gas is heated with a heat exchanger before the exhaust gas is supplied to a catalyst.

### SUMMARY

In contrast to this, it is an object of the invention to provide a method and a device of the initially mentioned kind, by which the consumption of fuels for the purpose of increasing the temperature of the exhaust gas or process gas, in particular nitrogen oxide flue gas, is reduced, and thus to provide a cost-efficient method and a cost-efficient device.

With the method of the initially mentioned kind this is achieved in accordance with the invention in that the oxidizable share, in particular the carbon monoxide share, is oxidized at least partially in particular to carbon dioxide for heating the nitrogen oxide flue gas. By means of the at least partial oxidation of the oxidizable share, in particular the carbon monoxide share, in the exhaust gas or process gas, in particular nitrogen oxide flue gas, the latent energy available in the gas is utilized, so that it is possible to achieve savings in the consumption of external fuels.

In order to achieve a partial oxidation of the oxidizable share, in particular the carbon monoxide share, in the exhaust gas or the nitrogen oxide flue gas, respectively, it is of advantage if a partial flow of the exhaust gas or process gas, in particular of the nitrogen oxide flue gas, is heated above the ignition temperature of the oxidizable share, in particular of carbon monoxide, preferably to 610° to 630° C. This ensures that the oxidizable share, in particular the carbon monoxide share, is oxidized in the partial flow and hence the heating value achieved during oxidation can be used.

In various technical applications, e.g. with sinter methods, the nitrogen oxide flue gas may be preheated by available waste heat in particular by means of heat exchangers. Consequently, it is of advantage for an energy-efficient method if the nitrogen oxide flue gas is heated, preferably to substantially 260° C., before the partial flow is branched off for further heating.

If the share of carbon monoxide prior to the oxidation thereof in the nitrogen oxide flue gas is below 12.5 percent by volume, preferably below 4 percent by volume, in particular between 0 and 2 percent by volume, the carbon monoxide share in the nitrogen oxide flue gas to be oxidized lies below the lower explosion limit of 12.5 percent by volume. Consequently, an independent reaction or flame formation due to the oxidation of the carbon monoxide share in the flue gas is not possible. Since the carbon monoxide share thus lies below the lower explosion limit, there results consequently in an advantageous manner that this method requires no specific safety-relevant provisions with respect to explosion protection.

To achieve the temperature that is expedient for a catalytic denitrification, it has turned out favourable if the amount of the heated partial flow is less than 15%, preferably between 3 and 7%, in particular substantially 5%, of the total amount of the nitrogen oxide flue gas. By this is it possible to preheat the nitrogen oxide flue gas to a (mixing) temperature of approx. 280° C. to 290° C. in a simple manner. To this end, the heated partial flow is mixed with the remaining nitrogen oxide flue gas before the flue gas denitrification is performed.

The device of the initially mentioned kind is characterized in that the exhaust gas or flue gas duct is in communication with at least one hot gas duct designed as a combustion chamber which is assigned with a combustion device, so that the oxidizable share, in particular the carbon monoxide share, of the exhaust gas or flue gas conducted through the hot gas duct is oxidized at least partially in particular to carbon dioxide. By providing a hot gas duct that is in communication with the exhaust gas or flue gas duct it is possible to achieve the oxidation in particular of the carbon monoxide share to carbon dioxide in the hot gas duct in a simple manner, and hence the heating of the exhaust gas or flue gas passed through the hot gas duct by means of oxidation in a simple manner.

With respect to the construction it is of particular advantage if the hot gas duct is accommodated in the flue gas duct. In this connection, it is of advantage for an expedient combustion of the oxidizable share, in particular the carbon monoxide share, if several hot gas ducts are provided, each of them being assigned with a combustion device.

If a main extension axis of the flue gas duct is arranged substantially vertically and the wall confining the at least one hot gas duct is suspended in an articulated manner in the flue gas duct, elongations of the walls of the hot gas ducts may be absorbed in a torque-free manner, and hence the entire duct construction comprising the flue gas duct and the hot gas duct is advantageously impacted with vertical loads only. The direction of flow of the flue gas is accordingly preferably a vertical direction, so that the flue gas flows from the bottom to the top in the flue gas duct and in the hot gas ducts designed as combustion chambers. Due to the higher flow rate of the comparatively cold gas outside of the hot gas ducts there results a high heat transfer coefficient at the comparatively cold side, so that it is advantageously ensured that the walls of the hot gas ducts, even if they are not insulated, are always sufficiently cooled and will consequently not overheat.

In order to be able to adjust and/or control the share of the flue gas that is conducted through the hot gas ducts, it is of advantage if every hot gas duct is assigned, at the side of entry of the gas, with an adjustable closing device, in particular a pivotable lid.

If a mixing chamber is connected to the at least one hot gas duct at the side of exit of the gas, the hot gas heated in the hot gas ducts due to the combustion of the carbon monoxide share to preferably approx. 610° C., is reliably mixed with the share of the flue gas that has not been heated further and that preferably has a temperature of approx. 260° C., after exiting from the hot gas ducts. In this connection it is favourable if the mixing chamber is confined by two walls that are provided with a plurality of openings, in particular sheets, which are arranged substantially transversely to the main extension axis of the flue gas duct. Individual portions of the walls extending substantially transversely to the flow direction of the flue gas and/or the main extension direction of the flue gas ducts, respectively, may be arranged at an angle to each other, so that the result is a substantially zigzag design of the mixing chamber in section.

Furthermore, for mixing the flue gas that is not conducted through the hot gas duct with the share that is conducted through the hot gas ducts, there may be provided even prior to the entry into the mixing chamber that the wall of the hot gas duct comprises at least one opening in an end portion thereof. In order to promote the entry of the cold gas into the respective hot gas duct, it may be advantageous if the opening is confined by at least one outwardly projecting lamella.

For the purpose of a reliable oxidation of the carbon monoxide share of the flue gas flowing through the hot gas ducts it is of advantage if the combustion device comprises a gas lance and a flame pipe which project into the hot gas duct.

### BRIEF DESCRIPTION OF THE DRAWINGS

In the following, the invention will be explained in detail by means of a preferred embodiment illustrated in the drawings, which, however, constitutes by no means a restriction of the invention.

In detail, the drawings show:

FIG. 1 a block diagram of a sinter unit with a degasification device and the partial oxidation of the sinter gas in accordance with the invention;

FIG. 2 a sectional view of a device in accordance with the invention for the purpose of partial combustion of the carbon monoxide share of a flue gas;

FIG. 3 a section along the line III-III in FIG. 2;

FIG. 4 a detail IV from FIG. 2;

FIG. 5 a section along the line V-V in FIG. 4; and

FIG. 6 a section along the line VI-VI in FIG. 4.

### DETAILED DESCRIPTION

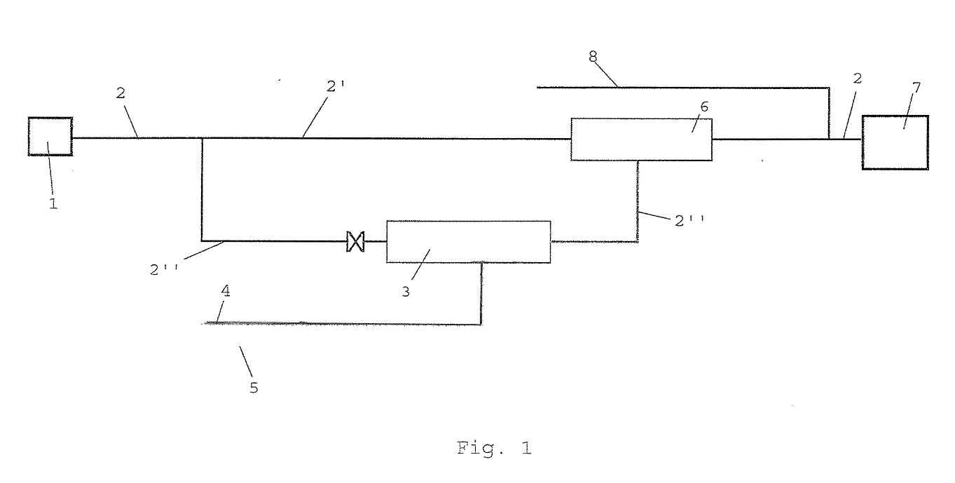

FIG. 1 schematically shows the method according to the invention in connection with a sinter unit 1. A sinter flow or the flue gas flow 2, respectively, exits from the sinter unit 1 after having been heated to approx. 260° C. by a plate heat exchanger. The flue gas flow 2 is separated into a flow 2′ that is not heated further and a partial flow 2″ that is supplied to a combustion chamber 3. Combustion air 4 and an oxidation gas 5, usually coke gas, are supplied to the combustion chamber 3 for the purpose of oxidizing the carbon monoxide share in the partial flow 2″. After the carbon monoxide share has been oxidized in the combustion chamber 3, the two (partial) flows 2′, 2″ are merged in a mixing chamber 6, so that the desired temperature of the flue gas is achieved prior to denitrification. In the embodiment shown, this temperature ranges at approx. 283° C., wherein subsequently, prior to the catalytic denitrification in the unit 7, a mixture 8 of carrying air and ammonia with a temperature of 25° C. is admixed, so that on entry into the denitrification unit 7 the sinter gas or flue gas 2, respectively, has the desired temperature for the catalytic denitrification of approx. 280° C.

By means of the feeding of the coke gas 5 into the combustion chamber 3 and the ignition thereof, which causes the ignition temperature of the carbon monoxide share in the flow 2″ of approx. 605° C. to be exceeded, the carbon monoxide share in the sinter gas 2″ oxidizes to carbon dioxide, so that the hot gas 2″ exiting the combustion chamber 3 has a temperature of approx. 615° C.

Due to this combustion of the carbon monoxide share in the partial flow 2″ of the sinter gas 2, the consumption of the coke gas 5 is substantially reduced as compared to an installation of burners heating the sinter gas 2 without an oxidation of the carbon monoxide share. In a simulation there was assumed that a sinter gas amount of approx. 720,000 Nm³/h with a temperature of approx. 260° C. exits the sinter gas unit 1 behind the plate heat exchanger. The entry temperature to a catalyst box of the denitrification unit 7, however, is to be 280° C. With a carbon monoxide share in the sinter gas of approx. 2 percent by volume there results that, without the combustion of the carbon monoxide share in the combustion chamber 3, a combustion or coke gas consumption of 1523 Nm³/h is required, whereas with the combustion of the carbon monoxide share in the combustion chamber 3 only 957 Nm³/h are required. Accordingly, the result is a saving of approx. 37% of the combustion gas 5, which means a substantial reduction of cost in operation.

FIG. 2 illustrates a device 7 in which a combustion chamber 3 and a mixing chamber 6 are combined in a joint construction. The combustion chamber 3 is composed of three separately designed hot gas ducts 3′ which are each confined by a wall 3″. The hot gas ducts 3′ are arranged in a flue gas duct 10′ that is positioned in the main connection duct between the sinter unit 1 and the denitrification unit 7.

The flue gas duct 10′ is confined by a wall 10. The main extension direction 10″ of the flue gas duct 10′ is the vertical direction, so that the flue gas 2 flows from the bottom to the top. The hot gas ducts 3′ designed as combustion chamber 3 are integrated in the flue gas ducts 10′, wherein the walls 3″ confining the hot gas ducts 3′ are, by means of a kind of hinged columns 11, suspended in an articulated manner at the wall 10 enclosing the flue gas duct 10′, so that elongations can be absorbed in a torque-free manner and the device 9 is impacted exclusively with vertical loads.

The flue gas flow 2 thus enters from the bottom and is separated into the partial flow 2″ flowing through the hot gas ducts 3′ and into the sinter gas flow 2′ flowing in the clearances and not being heated further. Due to the higher flow rate of the comparatively cold gas flow 2′ with respect to the hot gas flow 2″, a high heat transfer coefficient is given at the cold side, which ensures that the walls 3″ that are not insulated are sufficiently cooled and do not overheat. The walls 3″ of the chambers consist advantageously of a heat-proof sheet.

Below the individual hot gas ducts 3′ respective adjustable lids 12 are provided which enable to control the amount of the partial gas flow 2′. Advantageously, these lids 12 are provided with adjusting drives and comprise an automatic control that is not illustrated in detail.

A mixing chamber 6 that ensures a homogeneous mixture between the gas flow 2′ and the partial flow 2″ is provided in the area of the gas exit from the hot gas ducts 3′. Where appropriate, ammonia may be injected in this mixing zone already.

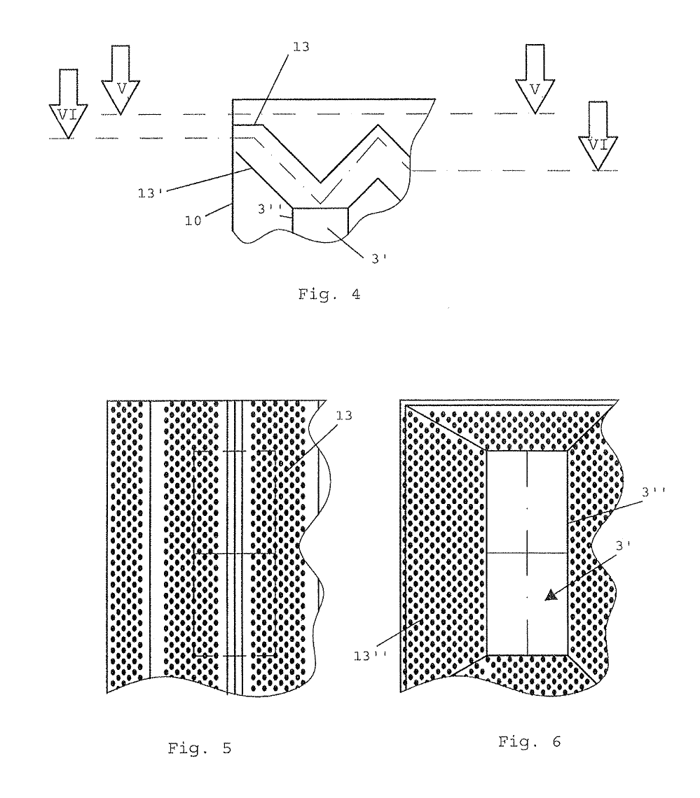

The design of the mixing zone is illustrated in detail in FIGS. 4 to 6, which show that the mixing chamber 6 comprises an upper perforated sheet 13 that is firmly connected with the wall 10 of the flue gas duct. A lower perforated sheet 13″ is connected with the respective wall 3″ of the corresponding hot gas duct 3′ and is consequently arranged to be moved with the wall 3″ in the flue gas duct 10′. The side view of FIG. 4 and/or FIG. 2 shows that the perforated sheets 13 are composed of several sections, each of them extending in an arrangement rising from the hot gas duct 3′ at both sides of the hot gas duct 3′. Thus, there results a substantially zigzag design of the mixing chamber 6, which promotes the mixing of the partial flows 2′ and 2″. The walls 3″ may comprise openings 16 confined by outwardly projecting lamellas 16′, so that a partial merging of the flows 2′, 2″ may take place already prior to the entry into the mixing chamber 6.

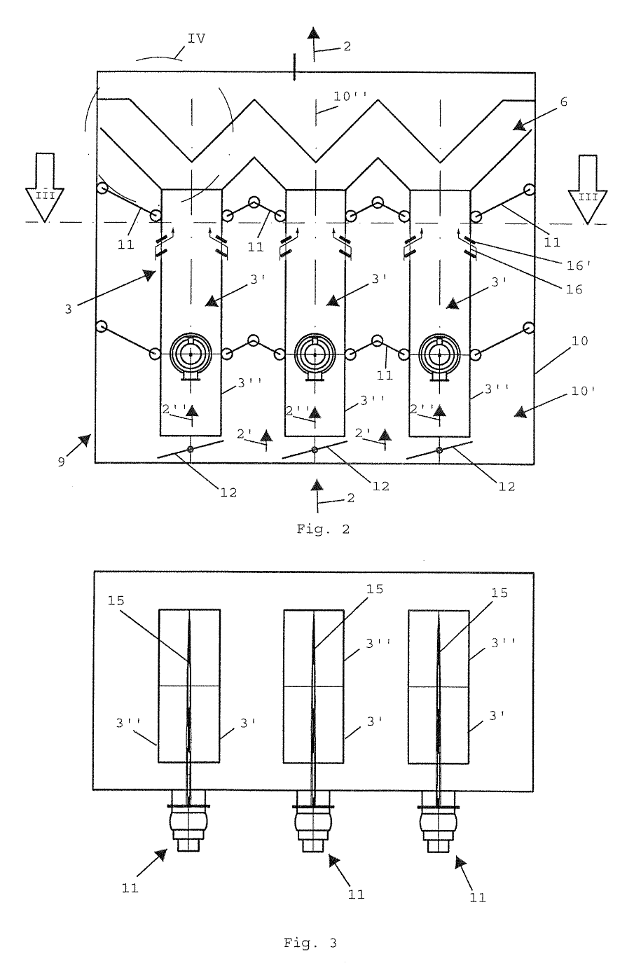

As is shown in particular in FIG. 3, each hot gas duct 3′ is provided with its own combustion device 11, wherein these combustion devices 11 comprise the per se known safety-technical monitoring equipment such as a UV cell and a temperature sensor.

Furthermore, the combustion devices 11 illustrated in FIG. 3 comprise a gas lance 15 and, in a per se known manner, a flame pipe (not illustrated), which project into the combustion chamber. The combustion devices 11 are connected to a gas safety and control path designed separately for each combustion device 11. This control path substantially consists of two quick acting valves connected in series and comprising intermediate venting and leak testing. Furthermore, a gas control valve (not illustrated) is provided which is a component of this control path in combination with the air control valve. A coke or combustion gas pressure increase fan (not illustrated) is positioned upstream of the control paths, said fan being provided to increase the gas pressure to 300 mbar. In order to prevent pollution of the fan, a fine filter of the kind known is positioned upstream of each fan. The performance of the combustion devices 11 is such that a quick start-up of the device 9 is possible after a standstill due to revision.

In addition, the combustion devices 11 each comprise their own ignition burner that is usually operated with natural gas. After the successful ignition of the main burner, this ignition burner is switched off, but still flown through with air for cooling. The combustion devices are—as illustrated in FIG. 1—supplied with combustion air via a central combustion air fan, wherein the ignition burners are also supplied via this fan. It will be appreciated that the ignition burners could alternatively also be operated with compressed air instead of combustion air from the combustion air fan.

What is essential is merely that the flue gas, for the purpose of heating, is heated prior to the supply to the denitrification unit 7 by means of at least partial oxidation of the oxidizable share, in particular the carbon monoxide share, to carbon dioxide. This achieves substantial saving of the consumption of fossil fuels and simultaneously also reduces the CO emission of the entire device.

1. A method for increasing the temperature of an exhaust gas or process gas with an oxidizable share, in particular a carbon monoxide-containing nitrogen oxide flue gas, before a catalytic flue gas denitrification is performed, comprising:
the oxidizable share, in particular the carbon monoxide share, is oxidized at least partially in particular to carbon dioxide for heating the nitrogen oxide flue gas.

2. The method according to claim 1, characterized in that a partial flow of the exhaust gas or process gas, in particular of the nitrogen oxide flue gas, is heated above the ignition temperature of the oxidizable share, in particular of carbon monoxide, preferably to 610° to 630° C.

3. The method according to claim 2, characterized in that the nitrogen oxide flue gas is heated preferably to substantially 260° C. before the partial flow is branched off for further heating.

4. The method according to claim 1, characterized in that a carbon monoxide-containing nitrogen oxide flue gas is provided as an exhaust gas or process gas, wherein the share of carbon monoxide prior to its oxidation in the nitrogen oxide flue gas is below 12.5 percent by volume, preferably below 4 percent by volume, in particular between 0 and 2 percent by volume.

5. The method according to claim 2, characterized in that the amount of the heated partial flow is less than 15%, preferably between 3 and 7%, in particular substantially 5%, of the total amount of the nitrogen oxide flue gas.

6. The method according to claim 2, characterized in that the heated partial flow is mixed with the remaining nitrogen oxide flue gas before flue gas denitrification is performed.

7. A device for increasing the temperature of an exhaust gas or process gas with an oxidizable share, in particular a carbon monoxide-containing nitrogen oxide flue gas, comprising: an exhaust gas or flue gas duct through which the exhaust gas or process gas, in particular the nitrogen oxide flue gas, is conducted, and a denitrification unit for the denitrification of the exhaust gas or process gas, the exhaust gas or flue gas duct is in communication with at least one hot gas duct designed as a combustion chamber which hot gas duct is assigned with a combustion device, so that the oxidizable share, in particular the carbon monoxide share, of the exhaust gas or flue gas conducted through the hot gas duct is oxidized at least partially in particular to carbon dioxide.

8. The device according to claim 7, characterized in that the hot gas duct is accommodated in the flue gas duct.

9. The device according to claim 7, characterized in that several hot gas ducts are provided, each of them being assigned with a combustion device.

10. The device according to claim 8, characterized in that a main extension axis of the flue gas duct is arranged substantially vertically, and that the wall confining the at least one hot gas duct is suspended in an articulated manner in the flue gas duct.

11. The device according to claim 7, characterized in that an adjustable closure device, in particular a pivotable lid, is assigned to each hot gas duct at the side of entry of the gas.

12. The device according to claim 7, characterized in that a mixing chamber is connected to the at least one hot gas duct at the side of exit of the gas.

13. The device according to claim 12, characterized in that the mixing chamber is confined by two walls, in particular sheets, provided with a plurality of openings and arranged substantially transversely to the main extension axis of the flue gas duct.

14. The device according to claim 7, characterized in that the wall of the hot gas duct comprises at least one opening in an end portion thereof.

15. The device according to claim 14, characterized in that the opening is confined by at least one outwardly projecting lamella.

16. The device according to claim 7, characterized in that the combustion device comprises a gas lance and a flame pipe which project into the hot gas duct.
